(19) United States
(12) Patent Application Publication
(10) Pub. No.: US 2007/0151477 A1
(43) Pub. Date: Jul. 5, 2007

(54) Hearth pad heat barrier

(76) Inventor: Robert A. Walker, Ramsey, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/522,845

(22) Filed: Sep. 18, 2006

Related U.S. Application Data
(63) Continuation of application No. PCT/US05/09211, filed on Mar. 18, 2005.
(60) Provisional application No. 60/555,023, filed on Mar. 18, 2004.

(51) Int. Cl. C09D 5/14

(52) U.S. Cl. 106/15.05; 126/500

(57) ABSTRACT

A hearth pad includes a first material, and a sufficient amount of borax to make the hearth pad fire resistant. A method of forming a hearth pad includes mixing a first material and borax, and applying pressure to the mixture of the first material and borax.

### RELATED APPLICATION

This application is a continuation under 35 U.S.C. 111(a) of PCT/US2005/009211, filed Mar. 18, 2005 and published as WO 2005/089501, filed Sep. 29, 2005, which claimed priority under 35 U.S.C. 119(e) to U.S. Provisional Application Ser. No. 60/555,023 filed Mar. 18, 2004, which applications and publication are incorporated herein by reference and made a part hereof.

### FIELD OF THE INVENTION

The present invention is related to a structure for a hearth apparatus and for the method or methods of making the structure.

### BACKGROUND OF THE INVENTION

A heat barrier must be provided between a furnace and any combustibles near the furnace. Many gas fired furnaces used to heat homes include the heat barrier in the furnace. Other types of furnaces do not include such a heat barrier. One type of furnace that must be provided with a heat barrier or insulated from combustible materials associated with a structure is a pot belly stove. The pot-belly stove is just one type of furnace that must be provided with a heat barrier or insulator to prevent heat from the furnace from igniting combustible materials near the furnace.

In many instances, bricks are used to provide such a heat barrier. A floor is formed of bricks. Bricks may even be used to line a wall near the furnace. If a more decorative heat barrier is desired, marble slabs can be used. Other installations may include ceramic tile. Generally, the heat barriers require some time to install. The heat barriers are also heavy and, as in the case of marble or tile, fragile. Once the heat barrier is installed, the furnace can be placed onto the heat barrier and the stack for removing excess heat and smoke is attached to the furnace before the furnace can be used.

### SUMMARY OF THE INVENTION

A hearth pad includes a first material, and a sufficient amount of borax to make the hearth pad fire resistant. The hearth pad, in some embodiments, includes a binder material. In other embodiments, the hearth pad also includes a second material.

A method of forming a hearth pad includes mixing a first material and borax, and applying pressure to the mixture of the first material and borax. The method, in some embodiments, further includes mixing a second material with the first material and the borax. In some embodiments, the method also includes mixing a binding material with the first material and the borax.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures, and:

FIG. 1 is perspective view a furnace positioned on a hearth pad apparatus or heat barrier, according to an embodiment of this invention.

FIG. 2 is a perspective view of the hearth pad apparatus or heat barrier, according to an embodiment of this invention.

FIG. 3 is a bottom view of the hearth pad apparatus or heat barrier, according to an embodiment of this invention.

FIG. 4 is a cut away side view of the hearth pad apparatus or heat barrier along line 4-4 in FIG. 3, according to an embodiment of this invention.

FIG. 5 is a schematic view of a manufacturing apparatus for making the hearth pad apparatus, according to an embodiment of this invention.

FIG. 6 is a flow diagram of a method for making the hearth pad apparatus, according to an embodiment of this invention.

FIGS. 7-10 are a set of figures showing various shapes of the hearth pad apparatus, according to different embodiments of this invention.

FIG. 11 is a bottom view of the hearth pad apparatus or heat barrier, according to an embodiment of this invention.

FIG. 12 is a bottom view of the hearth pad apparatus or heat barrier, according to an embodiment of this invention.

FIG. 13 is a bottom view of the hearth pad apparatus or heat barrier shown in FIG. 10, according to an embodiment of this invention.

The description set out herein illustrates the various embodiments of the invention, and such description is not intended to be construed as limiting in any manner.

### DETAILED DESCRIPTION

In the following detailed description of the preferred embodiments, reference is made to the accompanying drawings that form a part hereof, and in which are shown by way of illustration specific embodiments in which the invention can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of present inventions. The following detailed description, therefore, is not to be taken in a limiting sense, and the scope of various embodiments of the invention is defined only by the appended claims, along with the full range of equivalents to which such claims are entitled.

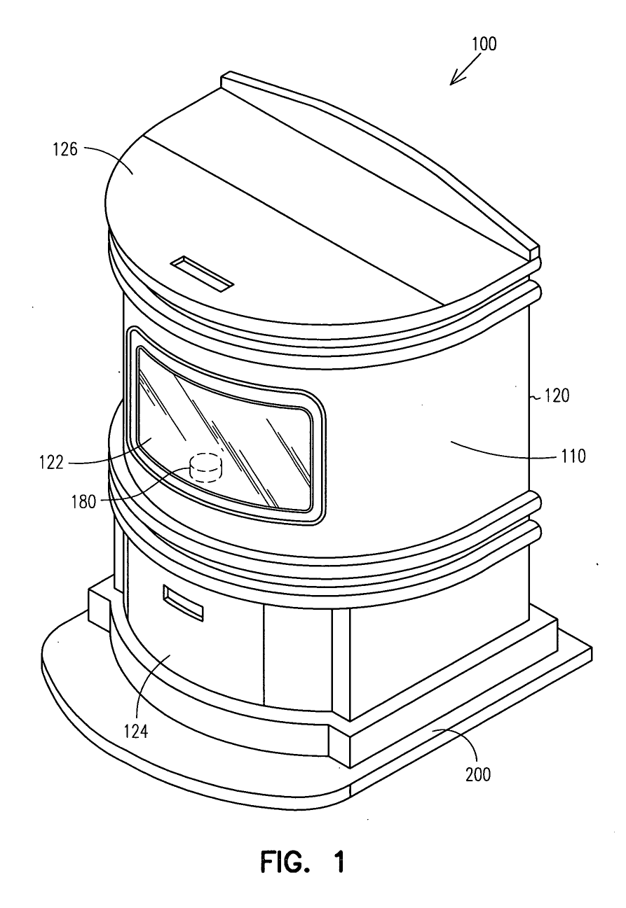

FIG. 1 is perspective view a furnace 100 positioned on a hearth pad apparatus 200 or heat barrier, according to an embodiment of this invention. The furnace 100 includes a housing 120. A combustion chamber 110 and a burn pot 180 are within the housing 120. At least a portion of the burn pot 180 and at least a portion of the combustion chamber 110 a viewable through a window 122. The window 122 is sealed with respect to the housing 120. The housing 120 also includes an access panel 124 that allows access to a portion of the interior of the furnace 100 located below the burn pot 180. The access panel, in some embodiments, allows users to remove combustion products from the furnace 100. The housing 120 also includes a hopper and a feed mechanism (not shown) for controllably placing biomass combustibles or other combustibles into the burn pot 180 in the combustion chamber 110. The housing 120 of the furnace includes a door 126 that allows access to the hopper (not shown). Biomass fuels are placed into the hopper after opening door 126. The furnace 100 is placed on a hearth pad apparatus 200. The hearth pad apparatus 200 prevents heat from the furnace from reaching combustibles near the furnace. As shown in FIG. 1, the hearth pad 200 prevents heat from reaching a floor on which the furnace 100 sits. Hearth pads could also be used to cover the walls or other areas near the furnace 100. It should be noted that this invention is useful for any type of furnace, stove or heat source that produces heat. The furnace 100, shown in FIG. 1, is one example of a furnace, stove or heat source where a hearth pad 200 is used to insulate the heat source from nearby combustibles.

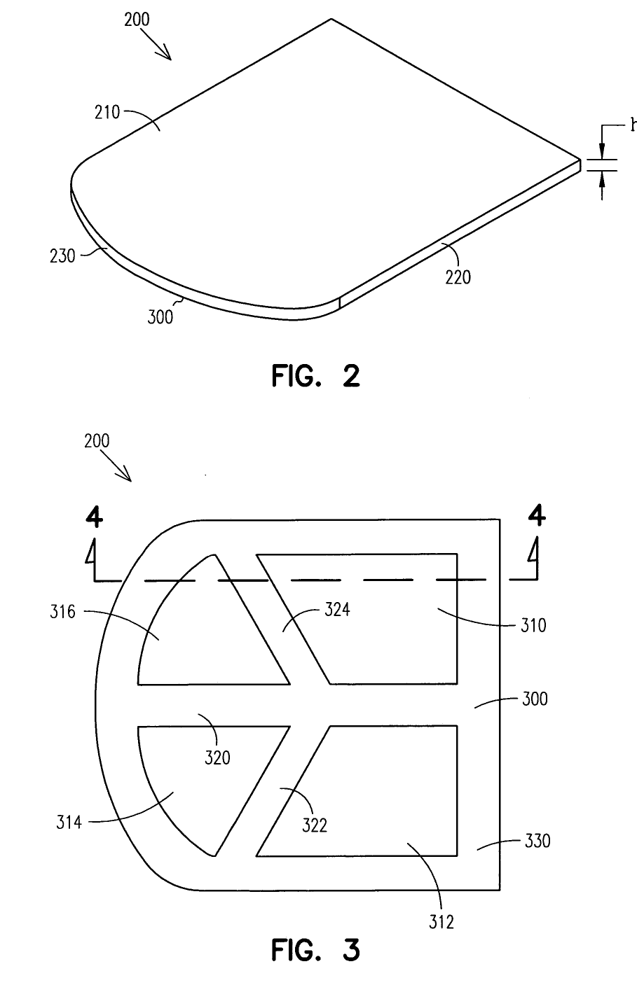

FIG. 2 is a perspective view of the hearth pad apparatus 200 or heat barrier, according to an embodiment of this invention. The hearth pad apparatus 200 includes a top surface 210, a bottom surface 300, a curved front end portion 230, and a side 220. The hearth pad 200 has a thickness or height, h. The hearth pad has a thickness h sufficient so that the material of the hearth pad apparatus 200 prevents heat flow between the furnace, which is positioned on the top surface 210 of the hearth pad 200, and the surface on which the hearth 200 rests. The hearth pad includes any number of types of material. In one embodiment of the hearth pad 200, the material used to form the hearth pad includes biomass materials. The types of biomass materials can be changed in order to produce different textures or “looks” on the visual surfaces of the hearth pad 200. For example, mixture of soy beans and news print can be mixed with a binder material and borax to form a hearth pad 200 that appears to have a marble-like pattern. The type of biomass material used is not limited to soybeans and news print. Other biomass materials can be mixed to form different designs on the surfaces 210, 220 of the hearth pad 200. For example, in some embodiments straw may be used as a biomass material. In some instances, other materials such as ground plastic can be added to produce different looks or finishes on the various surfaces of the hearth pad.

A heat resistive material, such as borax is placed into the mixture of the hearth pad in order to provide a resistance to heat. The heat resistive material, such as borax enables the hearth pad 200 to meet standards as a fire retardant. In embodiments of the invention that include borax, the amount of borax ranges between 25% to 10% by weight of the mixture. In still other embodiments, the borax that is added to the mixture comprises approximately 15% by weight of the mixture. A binder material is added to the mixture. In one embodiment, the binder includes a polymer which is in the range of approximately 2%-7% by weight of the mixture. In some embodiments, the polymer material is approximately 3% by weight of the mixture.

FIG. 3 is a bottom view of the hearth pad apparatus 200, according to an embodiment of the invention. The hearth pad 200 includes the bottom surface 300. The bottom surface 300 includes several relief areas, such as a relief area 310, a relief area 312, a relief area 314, and a relief area 316. The relief areas are formed to lighten the weight of the hearth pad 200. Between the relief areas 310, 312, 314, 316, are a series of strengthening ribs. As shown in FIG. 3, the bottom surface 300 includes a strengthening rib 320, a strengthening rib 322, and a strengthening rib 324. The strengthening ribs 320, 322, 324 are positioned between the relief areas 310, 312, 314 and 316 on the bottom surface 300 of the hearth pad 200.

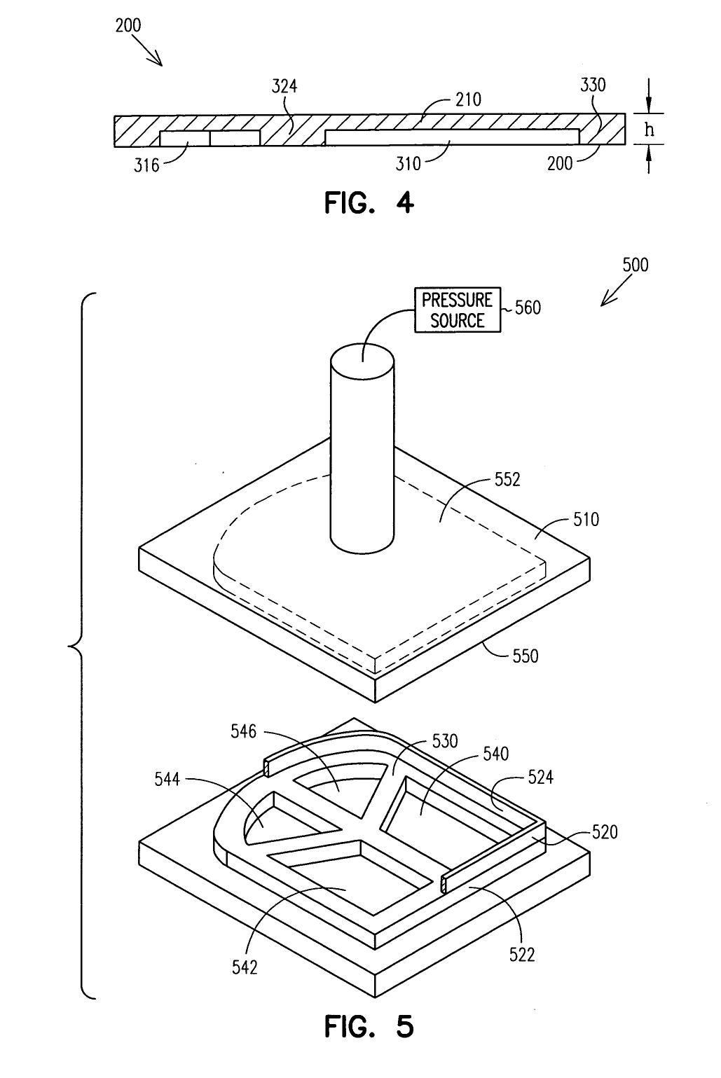

The bottom surface 300 also includes an edge 330 which circumscribes the outer perimeter of the bottom surface 300 of the hearth pad 200. The edge 330 and the ribs 320, 322, 324 each have a thickness h (see FIGS. 2 and 4). The number of strengthening ribs formed in the bottom surface 300 of the hearth pad 200 provides sufficient strength to bear the load of the furnace 100. It should be noted that the relief areas and the ribs need not necessarily be in the same arrangement as shown. Other arrangements of strengthening ribs could also be used. In addition, the relief areas may be more numerous, thereby presenting a web-like structure on the bottom surface 300 of the hearth pad 200.

Advantageously, the hearth pad 200 is much lighter than a similarly shaped portion of marble or a number of bricks or tile needed to cover an area substantially equivalent to the hearth pad. Thus, the furnace manufacturer or retailer can stock the hearth pad 200 and mail them for a reasonable rate to consumers. Even though the hearth pad is lighter than ceramic, brick or marble, the hearth pad 200 provides sufficient heat resistance and fire retardancy so that the furnace 100 will not ignite nearby combustible materials.

FIG. 4 is a cutaway side view of a hearth pad apparatus 200 or heat barrier along line 44 in FIG. 3, according to an embodiment of the invention. The cutaway side view of the hearth pad apparatus 200 shows the edge 330 which extends around the perimeter the hearth pad as well as the relief area 310 and the relief area 316. Also shown is the strengthening rib 324. It can be seen from FIG. 4 that the edge 330 and the strengthening rib 324 each have a thickness h which is the total thickness of the hearth pad 200. The relief areas 310 provide for a thickness which is less than the thickness h between the bottom surface at the relief area and the top surface 210. It should be noted that although this embodiment of the invention shows relief areas, such as relief area 310 and relief area 316, in other embodiments there may be no relief areas. In either case, the hearth pad apparatus has a weight that is substantially less than the weight of marble, brick, or ceramic, or other similar materials generally used as a heat barrier between a furnace and a combustible.

FIG. 5 is a schematic view of a manufacturing apparatus 500 for making the hearth pad apparatus, according to an embodiment of the invention. The manufacturing apparatus 500 includes a press 510 and a die 520. The die 520 includes sidewalls 522 and 524. As shown in FIG. 5, the sidewall 524 is broken away so that a bottom surface 530 of the die 520 is more easily viewed. The bottom surface 530 includes the reverse area, or a reverse volume, such as reverse volumes 540, 542, 544, and 546. The reverse volume form the relief areas 310,312, 314 and 316 in the bottom surface 300 of the hearth pad. The press 510 includes a bottom surface 550 having a shaped volume 552 (shown in phantom in FIG. 5). The shaped volume 552 corresponds to the shape of the die.

Also attached to the die is a source of pressure 560. The pressure source can be any type of pressure source including a mechanical or hydraulic press.

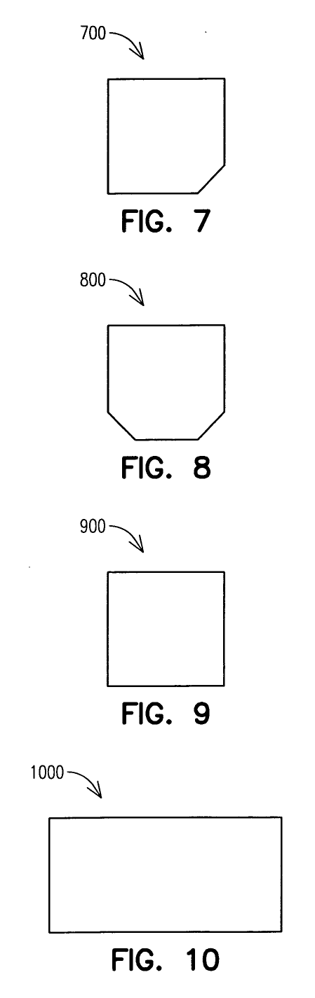

In FIG. 5, the hearth pad formed is similar to the hearth pad shown in FIGS. 1-4. It should also be noted that the hearth pad does not necessarily have to have the particular shape shown. Therefore the die 520 and the shaped volume 552 which mates with the die can have different shapes to form different styles and shapes of hearth pads. FIGS. 7-10, discussed below, show some of the different shapes and styles of hearth pads.

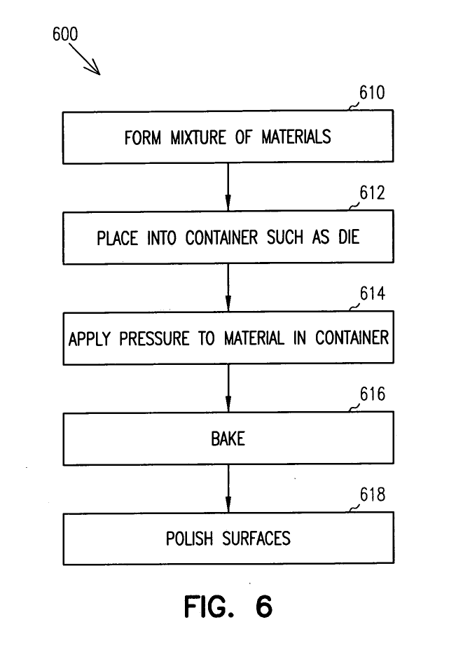

FIG. 6 is a flow diagram of a method 600 for forming or making the hearth pad apparatus or heat barrier, according to an embodiment of this invention. Now referring both to FIGS. 5 and 6, the method of manufacture or method of forming a hearth pad will be further detailed. Initially a mixture of materials is formed, as depicted by element 610. The mixture of materials includes at least a first material and sufficient borax to make the material meet all fire retardantcy standards required for under-stove hearth pads. In some embodiments, a second material is mixed with the first material and the borax. It should be noted that in some embodiments the first material and the second material are biomass materials such as soy bean, newsprint, straw, or any other biomass material. Additional materials may be added in order to achieve different textures on the surface of the hearth pad 200. A binder material can also be added to the mixture. In one embodiment the binder is a polymer that consists or comprises approximately 3% by weight of the material. The borax that is added to the material to enhance the fire retardancy ability of the material is approximately 10%-25% by weight. In some embodiments, the borax is approximately 15% by weight of the material. The material is placed into a container such as the die, as depicted by reference numeral 612. Pressure is applied to the material in the container, as depicted by reference numeral 614. The material is then baked, as depicted by reference numeral 616 so that the resultant hearth pad is sufficiently hard. The surfaces of the hearth pad can then be polished, as depicted by reference numeral 618. The polishing can be continued until the polished surface is glossy.

FIGS. 7-10 are a set of figures showing various shapes of the hearth pad apparatus that can be formed according to the different embodiments of this invention. FIG. 7 shows a hearth pad 700 which has a portion of a corner removed. This particular shape of hearth pad 700 is useful for placing a furnace, such as furnace 100, into the corner of a room. FIG. 8 shows another shape of a hearth pad 800. In this particular shape of hearth pad, two of the corners are truncated. This style of hearth pad may be used in much the same way as the hearth pad 200 shown in FIGS. 1-4. FIG. 9 shows a square hearth pad apparatus 900. Square hearth pad 900 may be useful for applications on the floor as well as applications on a wall near a furnace 100. FIG. 10 shows a hearth pad 1000 that is rectangular in shape which may be used for another wall application or on a horizontal surface. It should be noted that hearth pads can be formed in any type of shape.

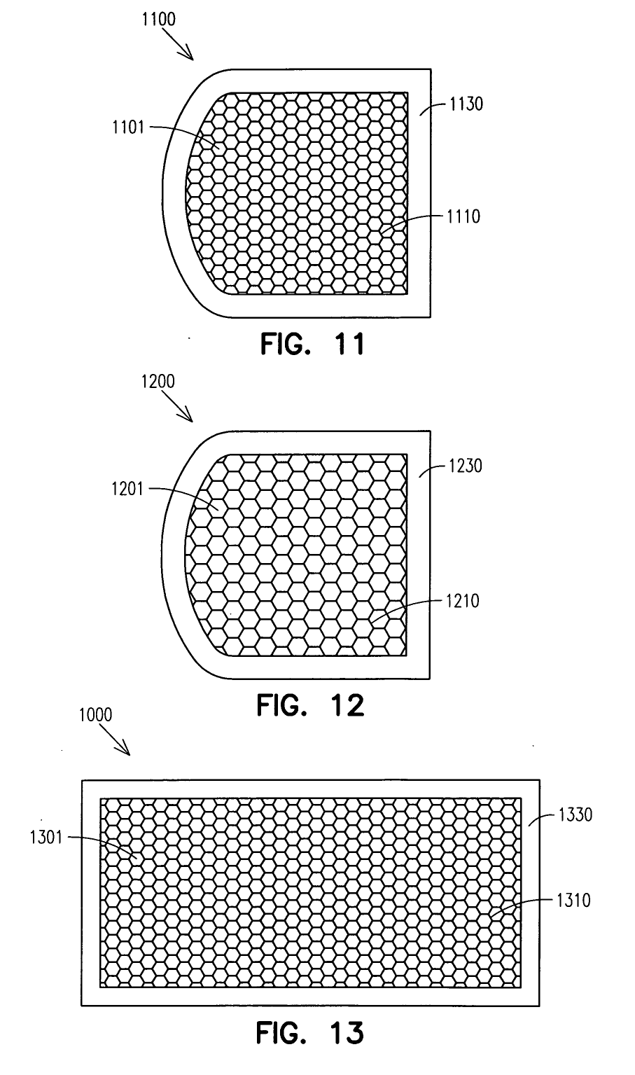

FIG. 11 is a bottom view of the hearth pad apparatus or heat barrier, according to an embodiment of this invention. The hearth pad or heat barrier 1100 includes a smooth or polished top surface, such as top surface 210 (shown in FIG. 2). The hearth pad 1100 also includes the bottom surface 1101. The bottom surface 1101 includes a rim 1120 that is positioned near or at the edge of the hearth pad 1100. The area of the bottom surface 1101 within the rim 1130 or edges of the hearth pad or heat barrier 1100 is formed in a honeycomb pattern 1110. The honeycomb pattern 1110 produces a plurality of relief areas that lighten the weight of the hearth pad 1100. The walls of the individual cells of the honeycomb can be formed of any thickness. The honeycomb structure 1110 generally is designed so that it can withstand an specified load. For example, for a hearth pad, the honeycomb structure 1110 is provided that can carry the load of a stove, such as the stove 100 shown in FIG. 1. The depth of the honeycomb pattern 1110 can also be set to provide sufficient strength to carry a selected load. Furthermore, the depth of the honeycomb pattern and the thickness of the walls of the honeycomb pattern 1110 are selected so that a portion of a stove, such as one having individual legs can be supported by the hearth pad 1100. Of course, if a hearth pad or heat barrier 1100 is also made of sufficient thickness so as to prevent substantial heat flow through the hearth pad or heat barrier 1100. The walls of the honeycomb cells also serve as a series of strengthening ribs. The height of the walls of each of the honeycomb cells and the height of the thickness of the top surface 200 is substantially equal to the thickness of the rim 1130 or edge and of the hearth pad or heat barrier 1100.

FIG. 12 is a bottom view of the hearth pad apparatus or heat barrier 1200, according to an embodiment of this invention. The hearth pad or heat barrier 1200 has many of the same elements as the hearth pad or heat barrier 1100 (shown in FIG. 11). As a result, the discussion of the hearth pad or heat barrier 1200 will key in on the differences between the hearth pad or heat barrier 1100 and the hearth pad or heat barrier 1200. The hearth pad or heat barrier 1200 includes a smooth or polished top surface, such as top surface 210 (shown in FIG. 2). The hearth pad or heat barrier 1200 also includes the bottom surface 1201. The bottom surface 1201 includes a rim 1220 that is positioned near or at the edge of the hearth pad 1200. The area of the bottom surface 1201 within the rim 1230 or edges of the hearth pad or heat barrier 1200 is formed in a honeycomb pattern 1210. The honeycomb pattern 1210 produces a plurality of relief areas that lighten the weight of the hearth pad or heat barrier 1200. Among the differences between the hearth pad or heat barrier 1100 and the hearth pad or heat barrier 1200 is the size of the honeycomb cells. The honeycomb cells in the honeycomb pattern 1200 are larger than the honeycomb cells in the honeycomb pattern 1100 (shown in FIG. 11). In addition, the walls of the individual cells of the honeycomb pattern 1200 are thicker than the walls of the individual cells of the honeycomb pattern 1100 (shown in FIG. 11). FIG. 12 shows that the walls of the honeycomb pattern 1200 can be formed of varying thicknesses and that the individual cell size of a honeycomb pattern can also be varied. Any honeycomb structure, such as honeycomb structure 1210, generally is designed so that it can withstand an specified load. For example, for a hearth pad, the honeycomb structure 1110 is provided that can carry the load of a stove, such as the stove 1100 shown in FIG. 1 or a stove having individual legs that concentrate the load in several areas on the hearth pad or heat barrier 1200. Of course, the hearth pad or heat barrier 1200 is also designed to have a sufficient resistance to heat flow so as to insulate the stove from other combustibles in an edifice, such as a home or business.

FIG. 13 is a bottom view of the hearth pad apparatus or heat barrier 1000 shown in FIG. 10, according to an embodiment of this invention. The hearth pad or heat barrier 1000 also includes the bottom surface 1301. The bottom surface 1301 includes a rim 1320 that is positioned near or at the edge of the hearth pad or heat barrier 1000. The area of the bottom surface 1301 within the rim 1330 or edges of the hearth pad or heat barrier 1000 is formed in a honeycomb pattern 1310. The honeycomb pattern 1310 produces a plurality of relief areas that lighten the weight of the hearth pad or heat barrier 1000. The walls of the honeycomb pattern 1310 can be formed of varying thicknesses and that the individual cell size of a honeycomb pattern can also be varied. Any honeycomb structure, such as honeycomb structure 1310, generally is designed so that it can withstand an specified load. For example, for a hearth pad, the honeycomb structure 1310 is provided that can carry the load of a stove, such as the stove 1100 shown in FIG. 1 or a stove having individual legs that concentrate the load in several areas on the hearth pad or heat barrier 1000. In another embodiment of the invention, the hearth pad or heat barrier 1000 may be designed for application to walls or vertical surfaces near a stove or furnace. In this embodiment, the honeycomb pattern 1310 could be designed to carry very little load since the application would be for insulative purposes. Of course, the hearth pad or heat barrier 1000, in either embodiment, is also designed to have a sufficient resistance to heat flow so as to insulate the stove from other combustibles in an edifice, such as a home or business.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

All publications, patents and patent applications are incorporated herein by reference. While in the foregoing specification this invention has been described in relation to certain preferred embodiments thereof, and many details have been set forth for purposes of illustration, it will be apparent to those skilled in the art that the invention is susceptible to additional embodiments and that certain of the details described herein may be varied considerably without departing from the basic principles of the invention.

What is claimed is:

1. A heat barrier comprising:
a first material; and
a sufficient amount of borax to make the hearth pad fire resistant.

2. The heat barrier of claim 1 further comprising a binder material.

3. The heat barrier of claim 1 wherein the first material includes a biomass material.

4. The heat barrier of claim 3 further comprising a binder material.

5. The heat barrier of claim 1 further comprising a second material.

6. The heat barrier of claim 5 wherein one of the first material or the second material includes a biomass material.

7. The heat barrier of claim 6 further comprising a binder material.

8. The heat barrier of claim 6 wherein the binder material is in the range of 2%-7% by weight of a mixture of the first material, the second material, the borax material, and the binder material.

9. The heat barrier of claim 6 wherein the borax material is in the range of 10%-25% by weight of a mixture of the first material, the second material, the binder material, and the borax material.

10. The heat barrier of claim 5 wherein the first material and the second material includes a biomass material.

11. The heat barrier of claim 8 further comprising a binder material.

12. The heat barrier of claim 1 wherein the borax material is in the range of 10%-25% by weight of a mixture of the first material and the borax material.

13. The heat barrier of claim 1 having a sufficient strength to support a furnace.

14. A heat barrier comprising:
a support surface;
an edge circumscribing the support surface; and
a structure for supporting the support surface that includes recesses therein.

15. The heat barrier of claim 14 wherein the structure for supporting the support surface includes a honeycomb structure.

16. The heat barrier of claim 14 wherein the structure for supporting the support surface includes at least one reinforcing rib.

17. The heat barrier of claim 14 wherein the structure for supporting the support surface includes at least one reinforcing rib and a honeycomb structure.

18. A method of forming a hearth pad comprising:
mixing a first material and borax;
applying pressure to the mixture of the first material and borax.

19. The method of claim 18 further comprising mixing a second material with the first material and the borax.

20. The method of claim 18 further comprising mixing a binding material with the first material and the borax.

21. The method of claim 18 further comprising mixing a binding material with the first material and the borax.

22. The method of claim 18 further comprising:
molding the mixture; and
baking the molded mixture.

23. The method of claim 22 further comprising polishing the baked and molded mixture.

24. The method of claim 22 further comprising pressurizing the mixture.
